(19) United States
(12) Patent Application Publication
(10) Pub. No.: US 2025/0260937 A1
(43) Pub. Date: Aug. 14, 2025

(54) AUDIO SIGNAL PROCESSING DEVICE

(71) Applicant: ALPS ALPINE CO., LTD., Tokyo (JP)

(72) Inventors: Kazumasa NIHIRA, Tokyo (JP); Keita TANNO, Tokyo (JP)

(21) Appl. No.: 19/037,833

(22) Filed: Jan. 27, 2025

(30) Foreign Application Priority Data
Feb. 9, 2024 (JP) 2024-018453

(51) Int. Cl. H04S 7/00; H04S 3/00

(52) U.S. Cl. CPC H04S 7/303; H04S 3/00

(57) ABSTRACT

An audio signal processing device for processing a surround audio signal, includes a plurality of harmonic addition circuits corresponding to a plurality of channels, respectively, and configured to perform an operation on a first surround audio signal, where the plurality of channels forming at least some of channels constituting the first surround audio signal. The operation of each harmonic addition circuit of the plurality of harmonic addition circuits includes adding, to a signal of a channel of the first surround audio signal, a harmonic signal in a predetermined band having a bass component of the signal as a fundamental tone, and outputting the signal of the channel added with the harmonic signal, and forming a second surround audio signal by replacing at least the signal of the channel of the first surround audio signal with the signal of the channel added with the harmonic signal.

### CROSS-REFERENCE TO RELATED APPLICATIONS

This application is based upon and claims priority to Japanese Patent Application No. 2024-018453, filed on Feb. 9, 2024, the entire contents of which are incorporated herein by reference.

### BACKGROUND

### 1. Field of the Invention

The present disclosure relates to surround audio signal processing technologies, and audio signal processing devices.

### 2. Description of the Related Art

As techniques for processing a surround audio signal, there are known techniques which generate a 5-channel surround audio signal of L, R, SL, SR, and C by upmixing a 2-channel stereo signal of L0 and R0 (refer to Japanese Laid-Open Patent Publications No. 2013-126116 and No. 2010-103768, for example).

In this case, L is a sum of a component of L0correlated with R0 and a component of L0 uncorrelated with R0. R is a sum of a component of R0 correlated with L0 and a component of R0 uncorrelated with L0. SL is a component of L0 uncorrelated with R0, and SR is a component of R0 uncorrelated with L0. C is a sum of a component of L0 correlated with R0 and a component of R0 correlated with L0. In addition, L is a signal for a speaker at the front left of a listener, and R is a signal for a speaker at the front right of the listener. SL is a signal for a speaker to a left direction or at the rear left of the listener, and SR is a signal for a speaker to a right direction or at the rear right of the listener. C is a signal for a speaker in at a front center of the listener.

As a technique for processing the surround audio signal, there is known a technique which downmixes a multi-channel surround audio signal, such as a 5.1-channel surround audio signal or the like, into a 2-channel stereo signal (refer to Japanese Laid-Open Patent Publication No. 2007-208709, for example).

Further, as downmixing technique, there is a known technique which performs a virtual surround processing for generating a stereo signal that creates a sense of spacious sound field when listened with headphones (refer to Japanese Laid-Open Patent Publications No. 2019-508964 and No. 2006-319802, for example).

In a case where the multi-channel surround audio signal, such as the 5-channel surround audio signal or the like, is generated from the 2-channel stereo signal, there is a problem in that a sense of localization of base sound is impaired when the surround audio signal is generated so as to provide a sense of spaciousness in a sound field.

Further, in a case where the 2-channel stereo signal is generated by downmixing the multi-channel surround audio signal, such as the 5-channel surround audio signal or the like, there is a problem in that the sense of localization of the base sound is insufficient when listened with the headphones.

Accordingly, there is a demand to process a surround audio signal without losing a sense of localization of the base sound.

### SUMMARY

It is an object in one aspect of the present disclosure to process a surround audio signal without losing a sense of localization of the base sound.

According to one aspect of an embodiment of the present disclosure, an audio signal processing device for processing a surround audio signal, includes a plurality of harmonic addition circuits corresponding to a plurality of channels, respectively, and configured to perform an operation on a first surround audio signal, the plurality of channels forming at least some of channels constituting the first surround audio signal, wherein the operation of each harmonic addition circuit of the plurality of harmonic addition circuits includes adding, to a signal of a channel of the first surround audio signal, a harmonic signal in a predetermined band having a bass component of the signal as a fundamental tone, and outputting the signal of the channel added with the harmonic signal, and forming a second surround audio signal by replacing at least the signal of the channel of the first surround audio signal with the signal of the channel added with the harmonic signal.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1A and FIG. 1B are diagrams for explaining a configuration of an audio signal processing device according to an embodiment of the present disclosure;

FIG. 2 is a diagram illustrating a configuration of a component separator which can be used for a surround audio signal generator according to the embodiment of the present disclosure;

FIG. 3 is a diagram illustrating a configuration of a harmonic addition block according to the embodiment of the present disclosure;

FIG. 4 is a diagram illustrating a frequency versus gain characteristic of a sound reaching an outer ear for each direction; and

FIG. 5A and FIG. 5B are diagrams for explaining another configuration example of the embodiment of the present disclosure.

### DETAILED DESCRIPTION

According to a first aspect of the present disclosure, an audio signal processing device for processing a surround audio signal, includes a plurality of harmonic addition circuits corresponding to a plurality of channels, respectively, and configured to perform an operation on a first surround audio signal, the plurality of channels forming at least some of channels constituting the first surround audio signal, wherein the operation of each harmonic addition circuit of the plurality of harmonic addition circuits includes adding, to a signal of a channel of the first surround audio signal, a harmonic signal in a predetermined band having a bass component of the signal as a fundamental tone, and outputting the signal of the channel added with the harmonic signal, and forming a second surround audio signal by replacing at least the signal of the channel of the first surround audio signal with the signal of the channel added with the harmonic signal.

According to a second aspect of the present disclosure, in the audio signal processing device of the first aspect, the operation of each harmonic addition circuit of the plurality of harmonic addition circuits may further include generating the harmonic signal in the predetermined band having the bass component of the signal as the fundamental tone, adjusting a magnitude of the generated harmonic signal having a gain according to a direction corresponding to a corresponding channel, and adding the harmonic signal having the adjusted gain to the signal of the corresponding channel of the first surround audio signal, to output the signal of the corresponding channel added with the harmonic signal having the adjusted gain, and the direction corresponding to the corresponding channel is a direction of a position of a speaker with respect to a listener in a case where the signal of the channel is output from the speaker.

According to a third aspect of the present disclosure, in the audio signal processing device of the second aspect, a first direction may be defined as a diagonally frontward left direction, a second direction may be defined as a diagonally frontward right direction, a third direction may be defined as a left direction or a diagonally backward left direction, and a fourth direction may be defined as a right direction or a diagonally backward right direction, with respect to the listener, the channels constituting the first surround audio signal may include at least four channels including a channel corresponding to the first direction, a channel corresponding to the second direction, a channel corresponding to the third direction, and a channel corresponding to the fourth direction, one harmonic addition circuit of the plurality of harmonic addition circuits may be provided in correspondence with each of the four channels, and the gain according to the first direction and the second direction may be larger than the gain according to the third direction and the fourth direction.

According to a fourth aspect of the present disclosure, in the audio signal processing device of the third aspect, a fifth direction may be defined as a front center direction, with respect to the listener, the channels constituting the first surround audio signal may include a channel corresponding to the fifth direction, one harmonic addition circuit of the plurality of harmonic addition circuits may be provided in correspondence with the channel corresponding to the fifth direction, and the gain according to the third direction and the fourth direction may be larger than the gain according to the fifth direction.

According to a fifth aspect of the present disclosure, in the audio signal processing device of any one of the first through fourth aspects, the predetermined band may include a band between 2 kHz and 3 kHz.

According to a sixth aspect of the present disclosure, the audio signal processing device of any one of the first through fourth aspects may further include a downmixer configured to generate a stereo audio signal from the second surround audio signal.

According to a seventh aspect of the present disclosure, the audio signal processing device of any one of the first through fourth aspects may further include a surround audio signal generator configured to generate the first surround audio signal from a stereo audio signal.

According to an eighth aspect of the present disclosure, the audio signal processing device of any one of the first through fourth aspects may further include a surround audio signal generator configured to generate the first surround audio signal from a first stereo audio signal, and a downmixer configured to generate a second stereo audio signal from the second surround audio signal.

According to a ninth aspect of the present disclosure, an audio signal processing device for processing a surround audio signal, includes a memory configured to store a program; and a processor configured to execute the program stored in the memory, wherein the program which, when executed by the processor, causes the processor to perform, with respect to a plurality of channels forming at least some of channels constituting a first surround audio signal, a process including adding, to a signal of a channel of the first surround audio signal, a harmonic signal in a predetermined band having a bass component of the signal as a fundamental tone, and outputting the signal of the channel added with the harmonic signal, and forming a second surround audio signal by replacing at least the signal of the channel of the first surround audio signal with the signal of the channel added with the harmonic signal.

According to the audio signal processing device described above, because the harmonic signal having the bass component of the channel as the fundamental tone is added to the signal of the channel and output for the plurality of channels of the first surround audio signal, the listener can feel the sense of localization of the bass sound as the fundamental tone by relying on the harmonic signal having a higher frequency band than the bass component and thus having higher directional recognition than the bass component.

In the case where the gain of the harmonic signal to be added is adjusted by the gain according to the direction corresponding to the channel, the gain difference matching a direction versus gain characteristic of a sound reaching an outer ear can be adjusted and output so as to be generated between the harmonic signals of the respective channels, and thus, the sense of localization of the bass sound achieved by adding the harmonic signal can further be enhanced.

Further, in this case, when the band of the harmonic signal added by adjusting the gain is set to a band including the band of 2 kHz to 3 kHz in which the gain difference for each direction is large in the direction versus gain characteristic of the sound reaching the outer ear, the sense of localization of the bass sound can be reliably and effectively enhanced by the gain adjustment.

A description will hereinafter be given of embodiments of the present disclosure with reference to the drawings.

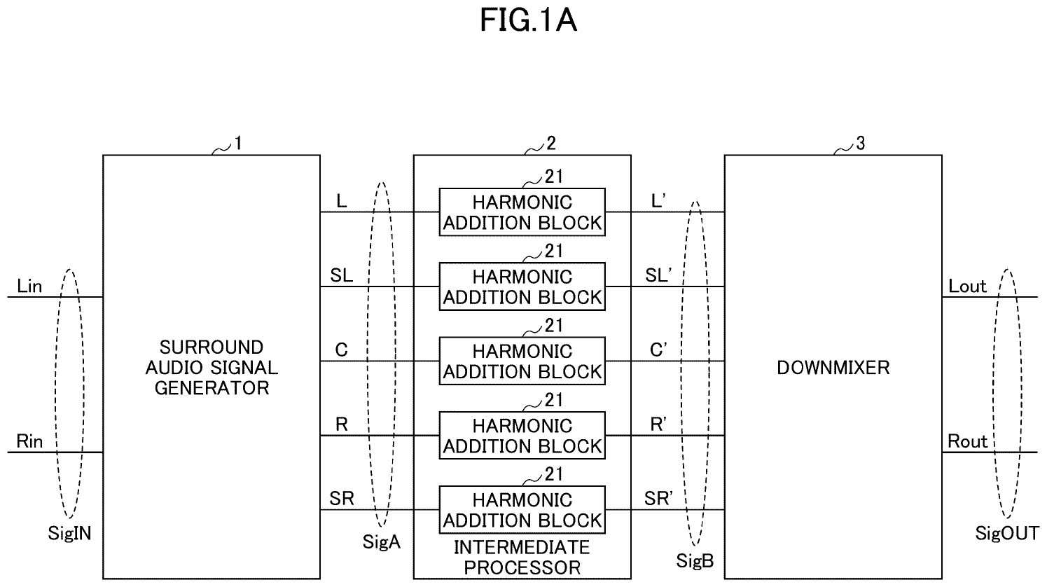

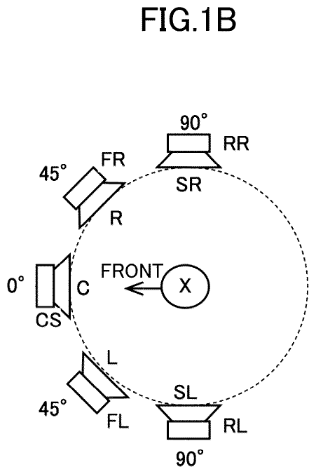

FIG. 1A illustrates a configuration of an audio signal processing device according to an embodiment.

As illustrated in FIG. 1A, the audio signal processing device includes a surround audio signal generator 1, an intermediate processor 2, and a downmixer 3. The surround audio signal generator 1 upmixes an input 2-channel stereo signal SigIN of Lin and Rin, and generates a 5-channel surround audio signal SigA of L, R, SL, SR, and C. The intermediate processor 2 processes the surround audio signal SigA generated by the surround audio signal generator 1, and outputs a 5-channel surround audio signal SigB of L′, R′, SL′, SR′, and C′. The downmixer 3 synthesizes and downmixes the 5-channel surround audio signal SigB of L′, R′, SL′, SR′, and C′ output from the intermediate processor 2, and outputs a 2-channel stereo signal SigOUT of Lout and Rout.

Each of the surround audio signal generator 1, the intermediate processor 2, and the downmixer 3 may be configured by an electronic circuit, such as a central processing unit (CPU), a field programmable gate array (FPGA), an application specific integrated circuit (ASIC), or the like. Alternatively, at least one of the surround audio signal generator 1, the intermediate processor 2, and the downmixer 3 may be configured by a computer including a processor and a memory. The processor executes one or more programs stored in the memory, such that the computer performs operations of at least one of the surround audio signal generator 1, the intermediate processor 2, and the downmixer 3.

The stereo signal SigOUT output from the downmixer 3 is a stereo signal for an audio output device including a pair of right and left speakers, such as stereo headphones, stereo earphones, or the like.

The audio signal processing device may be configured to output the surround audio signal SigA generated by the surround audio signal generator 1, as it is, to a 5-channel speaker system including real physical speakers.

In the surround audio signal SigA generated by the surround audio signal generator 1, L is a sum of a component of Lin correlated with Rin and a component of Lin uncorrelated with Rin. R is a sum of a component of Rin correlated with Lin and a component of Rin uncorrelated with Lin. SL is a component of Lin uncorrelated with Rin, and SR is a component of Rin uncorrelated with Lin. C is a sum of a component of Lin correlated with Rin and a component of Rin correlated with Lin.

In addition, when a front center direction of a listener is regarded as being a 0° direction, the surround audio signal SigA is a signal for a speaker system including a speaker FL at a left 45° direction of the listener, a speaker FR at a right 45° direction of the listener, a speaker RL at a left 90° direction of the listener, a speaker RR at a right 90° direction of the listener, and a speaker CS in front center of the listener, as illustrated in FIG. 1B. In this case, of the surround audio signal SigA, L denotes the signal for the speaker FL, R denotes a signal for the speaker FR, SL denotes a signal for the speaker RL, SR denotes a signal for the speaker RR, and C denotes a signal for the speaker CS.

The configuration of the surround audio signal generator 1 for generating the surround audio signal SigA may vary according to usage or the like. Basically, the surround audio signal generator 1 separates the component of Lin correlated with Rin, the component of Lin uncorrelated with Rin, the component of Rin correlated with Lin, and the component of Rin uncorrelated with Lin from Lin and Rin of the stereo signal SigIN, and combines the separated components and combines the separated components with Lin and Rin to generate L, R, SL, SR, and C of the surround audio signal SigA.

The separation of the correlated component and the uncorrelated component can be performed using a component separator having a configuration illustrated in

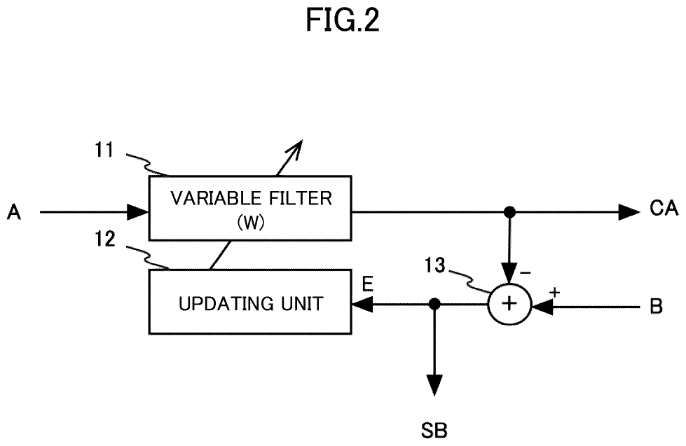

FIG. 2.

The component separator illustrated in FIG. 2 separates, from a signal A and a signal B, a component CA of the signal B correlated with the signal A and a component SB of the signal B uncorrelated with the signal A.

As illustrated in FIG. 2, the component separator includes a variable filter 11, an updating unit 12 that updates a transfer function (or filter coefficient) W of the variable filter 11 by an adaptive algorithm, such as a least means square (LMS) algorithm or the like, and an adder 13, The variable filter 11, the updating unit 12, and the adder 13 constitute an adaptive filter.

The variable filter 11 receives the signal A as an input. The adder 13 subtracts an output of the variable filter 11 from the signal B, and outputs a subtraction result as an output. The updating unit 12 performs an adaptive algorithm using the output of the adder 13 as an error E, and updates the transfer function W of the variable filter 11 so that a power of the error E is minimized.

The power of the output of the adder 13 becomes a minimum when the output of the variable filter 11 matches (or coincides with) the component CA of the signal B correlated with the signal A, and in this state, the output of the adder 13 obtained by subtracting the output of the variable filter 11 from the signal B represents the component SB of the signal B uncorrelated with the signal A.

Accordingly, the component CA of the signal B correlated with the signal A can be separated as the output of the variable filter 11, and the component SB of the signal B uncorrelated with the signal A can be separated as the output of the adder 13. Further, if the signal A of the signal B are interchanged, the component CB of the signal A correlated with the signal B and the component SA of the signal A uncorrelated with the signal B can be separated in a similar manner.

Referring back to FIG. 1, the intermediate processor 2 includes five harmonic addition blocks 21 corresponding to L, R, SL, SR, and C of the surround audio signal SigA, respectively. Each harmonic addition block 21 may be an electronic circuit, that is, a harmonic addition circuit, for example. Further, each harmonic addition block 21 may be a processor configured to execute a program stored in a memory, to perform functions of the harmonic addition block 21.

A corresponding signal among L, R, SL, SR, and C is input to each of the harmonic addition blocks 21. An output of the harmonic addition block 21 corresponding to

L is L′ of the surround audio signal SigB, an output of the harmonic addition block 21 corresponding to R is R′ of the surround audio signal SigB, an output of the harmonic addition block 21 corresponding to SL is SL′ of the surround audio signal SigB, an output of the harmonic addition block 21 corresponding to SR is SR′ of the surround audio signal SigB, and an output of the harmonic addition block 21 corresponding to C is C′ of the surround audio signal SigB.

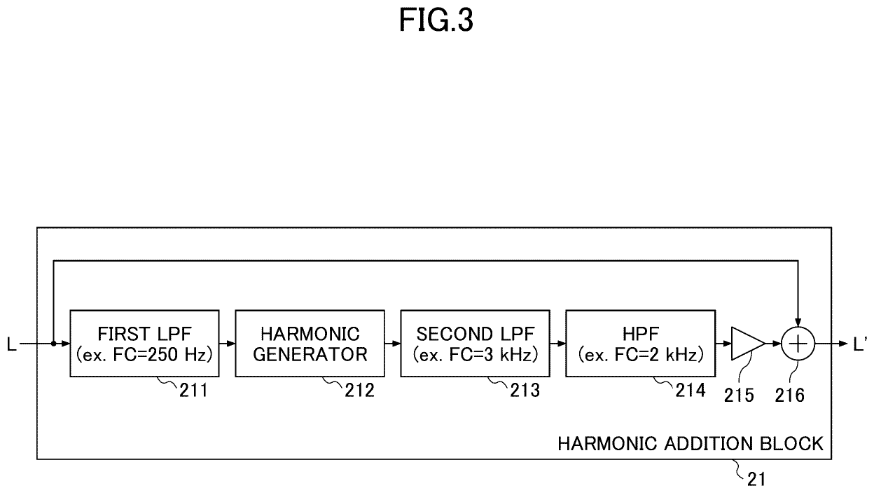

FIG. 3 illustrates a configuration of the harmonic addition block 21 of the intermediate processor 2.

Because the five harmonic addition blocks 21 have the same configuration, the configuration of the harmonic addition block 21 corresponding to L of the surround audio signal SigA is illustrated as a representative example.

As illustrated in FIG. 3, the harmonic addition block 21 includes a first lowpass filter (LPF) 211, a harmonic generator 212, a second LPF 213, a highpass filter (HPF) 214, an amplifier 215, and a synthesis unit 216.

The first LPF 211 is a lowpass filter for extracting a bass component (or a low-frequency component) of L of the surround audio signal SigA which is the input to the harmonic addition block 21. A cutoff frequency of the first LPF 211 is set to 250 Hz, for example, and the bass component of L in a low-frequency range lower than approximately 250 Hz is extracted and output.

The harmonic generator 212 generates a harmonic that is n times to m times (m>n), using the bass component of L extracted by the first LPF 211 as a fundamental tone (or fundamental frequency), and outputs the harmonic as the harmonic signal.

The harmonic signal output from the harmonic generator 212 is input to the amplifier 215 through the second LPF 213 and the HPF 214.

The second LPF 213 and the HPF 214 are a lowpass filter and a highpass filter constituting a bandpass filter for limiting a band of the harmonic signal. The band limitation performed by the second LPF 213 and the HPF 214 is performed by extracting the band including a band of approximately 2 kHz to approximately 3 KHz.

For example, by setting a cutoff frequency of the second LPF 213 to 3 kHz and setting a cutoff frequency of the HPF 214 to 2 kHz, respectively, the harmonic signal having the band of 2 kHz to 3 kHz is extracted and output to the amplifier 215.

A range of the multiple of the harmonic generated by the harmonic generator 212 (n times and m times described above) is set such that the harmonic within the band extracted by the second LPF 213 and the HPF 214 are included in the harmonic to be generated, with respect to the cutoff frequency of the first LPF 211.

Next, the amplifier 215 adjusts a level of the harmonic signal band limited in the second LPF 213 and the HPF 214 by a gain set for each harmonic addition block 21. The gain of the amplifier 215 set for each harmonic addition block 21 will be described later.

The synthesis unit 216 synthesizes the harmonic signal output from the amplifier 215 and L of the surround audio signal SigA input to the harmonic addition block 21, and outputs a synthesized signal as L′ of the surround audio signal SigB.

The configuration of the harmonic addition block 21 corresponding to R can be obtained by replacing L with R, and L′ with R′ in FIG. 3. The configuration of the harmonic addition block 21 corresponding to SL can be obtained by replacing L with SL, and L′ with SL′ in FIG. 3. The configuration of the harmonic addition block 21 corresponding to SR can be obtained by replacing L with SR, and L′ with SR′ in FIG. 3. The configuration of the harmonic addition block 21 corresponding to C can be obtained by replacing L with C, and L′ with C′ in FIG. 3.

As described above, the five harmonic addition blocks 21 have the same configuration, but the gain of the amplifier 215 is set for each harmonic addition block 21 as described above.

The gain of the amplifier 215 for each harmonic addition block 21 will be described below.

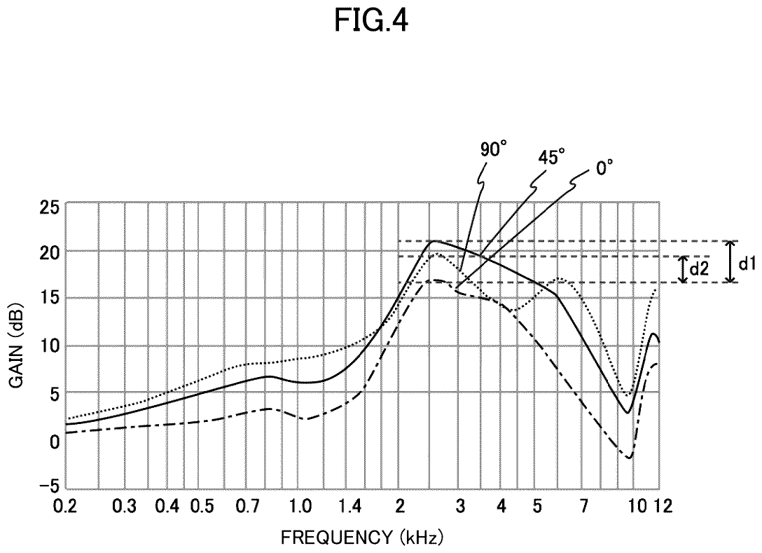

First, FIG. 4 is a diagram illustrating a frequency versus gain characteristic of a sound reaching an outer ear for each direction.

As illustrated in FIG. 4, the gain of the sound reaching the outer ear varies depending on the frequency of the sound, and also varies depending on the direction of a sound source.

In addition, in the band from 2 kHz to 3 kHz, the differences of the gains in the 0° direction, the 45° direction, and the 90° direction are conspicuous.

Further, in the band of 2 kHz to 3 kHz, the gain is largest in the 45° direction, second largest in the 90° direction, and third largest in the 0° direction in this descending order. The difference between the gains in the 45° direction and the 90° direction is approximately 2 dB on average, and the difference between the gains in the 90° direction and the 0° direction is approximately 2 dB on average.

Hence, as illustrated in FIG. 4, assuming that the difference between the gains in the 45° direction and the 0° direction in the band of 2 kHz to 3 kHz is d1, and the difference between the gains in the 90° direction and the 0° direction in the band of 2 kHz to 3 kHz is d2, the gains of the amplifiers 215 of the harmonic addition blocks 21 are set such that the gains of the amplifiers 215 of the harmonic addition blocks 21 corresponding to L and R of the surround audio signal SigA are d1 larger than the gain of the amplifier 215 of the harmonic addition block 21 corresponding to C of the surround audio signal SigA, and the gains of the amplifiers 215 of the harmonic addition blocks 21 corresponding to SL and SR of the surround audio signal SigA are d2 larger than the gain of the amplifier 215 of the harmonic addition block 21 corresponding to C of the surround audio signal SigA.

However, the gain of the amplifier 215 of each harmonic addition block 21 may be determined by further taking into consideration other conditions that affect the gain of the harmonic signals until Lout and Rout of the stereo signal SigOUT are output, such as the gains applied to L′, R′, SL′, SR′, and C′ during the synthesis when the downmixer 3 generates Lout and Rout of the stereo signal SigOUT.

In a case where the downmixer 3 adjusts the gain of each channel and synthesizes the channels, if the difference between the gains used for the adjustment is the same as the difference between the gains of the harmonic signals of the channels achieved by the gain adjustment of the amplifiers 215 in the embodiment described above, the amplifiers 215 may be omitted so as not to adjust the gains of the harmonic signals.

The embodiment of the present disclosure is described heretofore.

As described above, in the present embodiment, the harmonic signal having the bass component of each channel of the surround audio signal SigA as the fundamental tone is added to the signal of each channel and output. Hence, the listener can sense the localization of the bass sound as the fundamental tone, by relying on the harmonic signal having a higher frequency band than the bass component and thus having higher directional awareness than the bass component.

Moreover, because the gains of the harmonic signals to be added to the respective channels are adjusted and output so that the gain difference matching a direction versus gain characteristic of the sound reaching the outer ear is generated between the harmonic signals of the respective channels, the sense of localization of the bass sound achieved by the addition of the harmonic signals can further be enhanced.

Further, because the band of the harmonic signal added to each channel by adjusting the gain is set to the band of 2 kHz to 3 kHz in which the gain difference for each direction becomes large in the direction versus gain characteristic of the sound reaching the outer ear, the sense of localization of the bass sound can be enhanced reliably and effectively by the gain adjustment.

In the embodiment described above, the band of the bass using the fundamental tone of the harmonic signal to be added is set to the band of 250 Hz or lower. However, this band may be set to another band, such as a band of 100 Hz or lower, a band of 100 Hz to 200 Hz, or the like according to the band of the bass in which the sense of localization is to be enhanced in the actual use and application.

In the embodiment described above, the intermediate processor 2 receives the 5-channel surround audio signal SigA generated by the surround audio signal generator 1 as the input, and generates the 5-channel surround audio signal SigB by adding the harmonic signal to each of the 5 channels of the surround audio signal SigA. However, in a case where n is an arbitrary number greater than 4, the surround audio signal generator 1 may be configured to generate the n-channel or n.1-channel surround audio signal SigA, and the intermediate processor 2 may be configured to generate the surround audio signal SigB added with the harmonic signal to some or all of the channels of the surround audio signal SigA.

In addition, the surround audio signal generator 1 may be omitted. In this case, with respect to a n-channel or n.1-channel surround audio signal SigS serving as an audio source, the intermediate processor 2 may be configured to generate the surround audio signal SigB by adding the harmonic signal to predetermined channels including L, R, SL, and SR of the surround audio signal SigS.

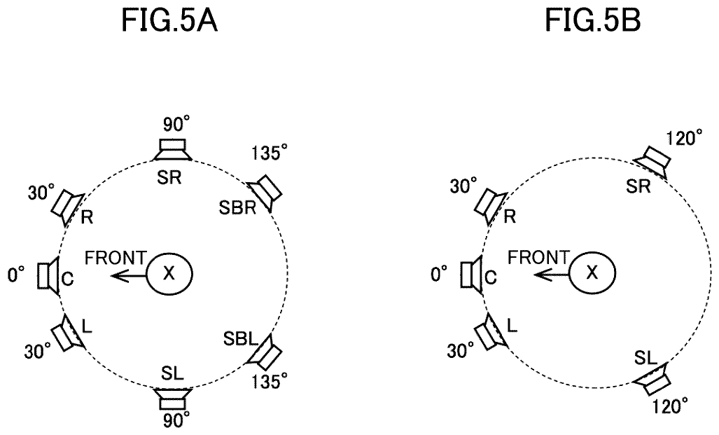

In a case where the audio source is a 8-channel surround audio signal SigS that includes L assuming an output from a speaker in a left 30° direction of the listener, R assuming an output from a speaker in a right 30° direction of the listener, SL assuming an output from a speaker in a left 90° direction of the listener, SR assuming an output from a speaker in a right 90° direction of the listener, C assuming an output from a speaker in front center of the listener, SBL assuming an output from a speaker in a diagonally backward left 135° direction of the listener, and SBR assuming an output from a speaker in a diagonally backward right 135° direction of the listener as illustrated in FIG. 5A, for example, the intermediate processor 2 may generate the surround audio signal SigB by adding the harmonic signal to only L, R, SL, and SR of the surround audio signal SigS by the harmonic addition block 21 as described above.

In the embodiment described above, the surround audio signal SigB generated by the intermediate processor 2 may be output to a speaker system including a plurality of real physical speakers corresponding to the channels of the surround audio signal.

In this case, the gain of the amplifier 215 of each harmonic addition block 21 in the intermediate processor 2 may be determined by taking into consideration an arrangement (or layout) of the speakers of the speaker system.

FIG. 5B illustrates an example of a case where the speaker system includes a speaker in the left 30° direction of the listener for outputting L of the 5-channel surround audio signal, a speaker in the right 30° direction of the listener for outputting R of the 5-channel surround audio signal, a speaker in the diagonally backward left 120° direction of the listener for outputting SL of the 5-channel surround audio signal, a speaker in the diagonally backward right 120° direction of the listener for outputting SR of the 5-channel surround audio signal, and a speaker in front center of the listener for outputting C of the 5-channel surround audio signal. In this case, the outputs of the harmonic addition blocks 21 are output to the speakers for outputting the corresponding channels. Moreover, the gains of the amplifiers 215 of the harmonic addition blocks 21 corresponding to L and R of the surround audio signal SigA output from the speakers that are diagonally in front center of the listener are set to be larger than the gain of the amplifier 215 of the harmonic addition block 21 corresponding to C of the surround audio signal SigA. Further, the gains of the amplifiers 215 of the harmonic addition blocks 21 corresponding to SL and SR of the surround audio signal SigA output from the speakers that are diagonally behind the listener are set to be smaller than the gain of the amplifier 215 of the harmonic addition block 21 corresponding to C of the surround audio signal SigA.

However, the gain of the amplifier 215 of each harmonic addition block 21 may be determined by further taking into consideration other conditions that affect the gain of the harmonic signal until the harmonic signal reaches the outer ear of the listener, such as the differences in the directions and the distances of the speakers with respect to the listener.

In addition, in a case where a difference in the gains of the sound of the channels reaching the outer ear of the listener from the speakers, caused by the difference in the actual directions of the speakers with respect to the listener, is the same as the difference in the gains of the harmonic signals of the channels achieved by the gain adjustment of the amplifiers 215 in the embodiment described above, the amplifiers 215 may be omitted so as not to adjust the gains of the harmonic signals.

As described above, according to the present disclosure, it is possible to process the surround audio signal without losing the sense of localization of the base sound.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An audio signal processing device for processing a surround audio signal, comprising:
a plurality of harmonic addition circuits corresponding to a plurality of channels, respectively, and configured to perform an operation on a first surround audio signal, the plurality of channels forming at least some of channels constituting the first surround audio signal,
wherein the operation of each harmonic addition circuit of the plurality of harmonic addition circuits includes:
adding, to a signal of a channel of the first surround audio signal, a harmonic signal in a predetermined band having a bass component of the signal as a fundamental tone, and outputting the signal of the channel added with the harmonic signal, and
forming a second surround audio signal by replacing at least the signal of the channel of the first surround audio signal with the signal of the channel added with the harmonic signal.

2. The audio signal processing device as claimed in claim 1, wherein the operation of each harmonic addition circuit of the plurality of harmonic addition circuits further includes:
generating the harmonic signal in the predetermined band having the bass component of the signal as the fundamental tone,
adjusting a magnitude of the generated harmonic signal having a gain according to a direction corresponding to a corresponding channel, and
adding the harmonic signal having the adjusted gain to the signal of the corresponding channel of the first surround audio signal, to output the signal of the corresponding channel added with the harmonic signal having the adjusted gain, and
the direction corresponding to the corresponding channel is a direction of a position of a speaker with respect to a listener in a case where the signal of the channel is output from the speaker.

3. The audio signal processing device as claimed in claim 2, wherein:
a first direction is defined as a diagonally frontward left direction, a second direction is defined as a diagonally frontward right direction, a third direction is defined as a left direction or a diagonally backward left direction, and a fourth direction is defined as a right direction or a diagonally backward right direction, with respect to the listener,
the channels constituting the first surround audio signal include at least four channels including a channel corresponding to the first direction, a channel corresponding to the second direction, a channel corresponding to the third direction, and a channel corresponding to the fourth direction,
one harmonic addition circuit of the plurality of harmonic addition circuits is provided in correspondence with each of the four channels, and
the gain according to the first direction and the second direction is larger than the gain according to the third direction and the fourth direction.

4. The audio signal processing device as claimed in claim 3, wherein:
a fifth direction is defined as a front center direction, with respect to the listener,
the channels constituting the first surround audio signal include a channel corresponding to the fifth direction,
one harmonic addition circuit of the plurality of harmonic addition circuits is provided in correspondence with the channel corresponding to the fifth direction, and
the gain according to the third direction and the fourth direction is larger than the gain according to the fifth direction.

5. The audio signal processing device as claimed in claim 1, wherein the predetermined band includes a band between 2 kHz and 3 kHz.

6. The audio signal processing device as claimed in claim 1, further comprising:
a downmixer configured to generate a stereo audio signal from the second surround audio signal.

7. The audio signal processing device as claimed in claim 1, further comprising:
a surround audio signal generator configured to generate the first surround audio signal from a stereo audio signal.

8. The audio signal processing device as claimed in claim 1, further comprising:
a surround audio signal generator configured to generate the first surround audio signal from a first stereo audio signal; and
a downmixer configured to generate a second stereo audio signal from the second surround audio signal.

9. An audio signal processing device for processing a surround audio signal, comprising:
a memory configured to store a program; and
a processor configured to execute the program stored in the memory,
wherein the program which, when executed by the processor, causes the processor to perform, with respect to a plurality of channels forming at least some of channels constituting a first surround audio signal, a process including:
adding, to a signal of a channel of the first surround audio signal, a harmonic signal in a predetermined band having a bass component of the signal as a fundamental tone, and outputting the signal of the channel added with the harmonic signal, and
forming a second surround audio signal by replacing at least the signal of the channel of the first surround audio signal with the signal of the channel added with the harmonic signal.

10. The audio signal processing device as claimed in claim 9, wherein the processor performs the process further including:
generating the harmonic signal in the predetermined band having the bass component of the signal as the fundamental tone,
adjusting a magnitude of the generated harmonic signal having a gain according to a direction corresponding to a corresponding channel, and
adding the harmonic signal having the adjusted gain to the signal of the corresponding channel of the first surround audio signal, to output the signal of the corresponding channel added with the harmonic signal having the adjusted gain,
wherein the direction corresponding to the corresponding channel is a direction of a position of a speaker with respect to a listener in a case where the signal of the channel is output from the speaker.

11. The audio signal processing device as claimed in claim 10, wherein:
a first direction is defined as a diagonally frontward left direction, a second direction is defined as a diagonally frontward right direction, a third direction is defined as a left direction or a diagonally backward left direction, and a fourth direction is defined as a right direction or a diagonally backward right direction, with respect to the listener,
the channels constituting the first surround audio signal include at least four channels including a channel corresponding to the first direction, a channel corresponding to the second direction, a channel corresponding to the third direction, and a channel corresponding to the fourth direction,
the process is performed with respect to each of the four channels, and
the gain according to the first direction and the second direction is larger than the gain according to the third direction and the fourth direction.

12. The audio signal processing device as claimed in claim 11, wherein:
a fifth direction is defined as a front center direction, with respect to the listener,
the channels constituting the first surround audio signal include a channel corresponding to the fifth direction,
the process is performed with respect to the channel corresponding to the fifth direction, and
the gain according to the third direction and the fourth direction is larger than the gain according to the fifth direction.

13. The audio signal processing device as claimed in claim 9, wherein the predetermined band includes a band between 2 kHz and 3 kHz.

14. The audio signal processing device as claimed in claim 9, further comprising:
a downmixer, coupled to the processor, and configured to generate a stereo audio signal from the second surround audio signal received from the processor.

15. The audio signal processing device as claimed in claim 9, further comprising:
a surround audio signal generator, coupled to the processor, and configured to generate the first surround audio signal from a stereo audio signal and supply the first surround audio signal to the processor.

16. The audio signal processing device as claimed in claim 9, further comprising:
a surround audio signal generator, coupled to the processor, and configured to generate the first surround audio signal from a first stereo audio signal and supply the first surround audio signal to the processor; and
a downmixer, coupled to the processor, and configured to generate a second stereo audio signal from the second surround audio signal received from the processor.
